(19) United States
(12) Patent Application Publication
(10) Pub. No.: US 2005/0220954 A1
(43) Pub. Date: Oct. 6, 2005

(54) Process and system for making shaped snack products

(76) Inventors: Kyle E. Dayley, Rigby, ID (US); Bradley Cole Frazee, Idaho Falls, ID (US)

Correspondence Address: STEPHEN A GRATTON;THE LAW OFFICE OF STEVE GRATTON, 2764 SOUTH BRAUN WAY, LAKEWOOD, CO, 80228, US

(21) Appl. No.: 10/812,656

(22) Filed: Mar. 30, 2004

(51) Int. Cl. A21D 6/00

(52) U.S. Cl. 426/503

(57) ABSTRACT

A process for making shaped snack products includes the steps of cutting dough pieces in a dough sheet, and then separating the dough pieces from a web scrap. The separating step can be performed by directing pressurized gas at the dough pieces, while moving separated dough pieces, and while moving the web scrap at an angle relative to the dough pieces. A system for performing the process includes a cutter mechanism having cutting segments with stepped cutting edges configured to cut the dough pieces with continuous sealed and shaped edges. The system also includes a gas discharge system for directing pressurized gas at the dough pieces during separation from the web scrap. In addition, the system includes a web scrap mechanism configured to move and orient the web scrap during separating of the dough pieces. A snack product includes two cooked dough layers having a continuous double thickness shaped edge along an outer periphery thereof, and a sealed chamber forming a center portion thereof.

### FIELD OF THE INVENTION

This invention relates generally to snack products, and particularly to a process and system for making shaped snack products.

### BACKGROUND OF THE INVENTION

Sheeted snack products are made by cutting dough pieces from a dough sheet, and then frying, baking or otherwise cooking the cut dough pieces. Examples of this type of snack product include “DORITOS” manufactured by Frito-Lay Inc., “PRINGLES” manufactured by the Proctor & Gamble Company, and “GOLDFISH” manufactured by Pepperidge Farms Inc.

In a high volume fabrication process, a cutter cuts each dough piece in a required size and shape from a continuous sheet of dough. Dough pieces for snack products which have a certain geometric shape, such as triangles and rectangles, can be cut from the dough sheet without producing any scrap dough. However, dough pieces for snack products having other shapes, such as ovals and animal forms, produce scrap dough, which is referred to in the industry as “web scrap”. Although the web scrap can be recycled into new dough sheets, it is desirable to produce as little web scrap as possible during cutting of the dough pieces.

Another consideration during the cutting step is the separation of the dough pieces from the web scrap. Dough pieces for snack products which are small and have intricate features, are more difficult to separate from the web scrap than dough pieces for larger featureless snack products. In general, intricate features produce multiple connecting points with the web scrap, which can prevent separation of the dough pieces from the web scrap. These intricate features can also break during separation, causing the snack products to have inconsistent shapes.

Closely spaced dough pieces can also be difficult to separate from the web scrap. In this case, only thin strands of web scrap separate adjacent dough pieces. These thin strands can flex, preventing separation of the dough pieces, or can move with the dough pieces and tear away from the web scrap.

The present invention is directed to a process and system for making shaped snack products in which cut dough pieces are separated from a dough sheet in an efficient manner and with a minimum of web scrap. In addition, the process and system can be used to produce snack products having a unique appearance, structure and texture.

### SUMMARY OF THE INVENTION

In accordance with the present invention, a process and a system for making shaped snack products are provided. Also provided are shaped snack products fabricated using the process.

The process, simply stated, includes the steps of: providing a dough sheet; cutting dough pieces in the dough sheet separated by a web scrap; and then separating the dough pieces from the web scrap. The separating step can be performed by directing a pressurized gas stream at the dough pieces, while moving the dough pieces, and moving the web scrap at an angle relative to the dough pieces.

The system includes a cutter assembly configured to cut the dough sheet into a plurality of separate dough pieces having one or more selected shapes. In an illustrative embodiment, the cutter assembly includes a rotating cylindrical cutter mechanism operably associated with a rotating back up roller. In addition, the cutter mechanism includes multiple cutting segments comprising shaped blades having cutting edges configured to shape and seal the cut edges of the dough pieces. The system also includes a gas discharge system configured to direct separate gas streams at the dough pieces contained in the cutting segments. In addition, the system includes a web scrap mechanism configured to move and orient the web scrap relative to the dough pieces, as the gas streams are directed at the dough pieces held in the cutting segments.

In an illustrative embodiment, the snack product comprises a multi-layered fried chip having a continuous shaped and sealed peripheral edge, and a hollow interior chamber. With a multi layered dough the peripheral edge has a double thickness, and provides a rigid peripheral support structure for the snack product and features thereof.

### BRIEF DESCRIPTION OF THE DRAWINGS

FIG. 1A is a schematic cross sectional view of a system for making snack products in accordance with the invention and with the system shown in a first position;

FIG. 1B is a schematic cross sectional view of the system and with the system shown in a second position;

FIG. 2A is an enlarged portion of FIG. 1B illustrating a cutter and a web scrap conveyor of the system during separation of dough pieces from a web scrap;

FIG. 2B is a plan view of a portion of the web scrap taken along line 2B of FIG. 2A;

FIG. 2C is a plan view of a dough piece (rabbit) taken along line 2C of FIG. 2A;

FIG. 2D is a plan view of a dough piece (duck) taken along line 2D of FIG. 2A;

FIG. 2E is a plan view of a dough piece (bird) taken along line 2E of FIG. 2A;

FIG. 2F is a plan view of a dough piece (cat) taken along line 2F of FIG. 2A;

FIG. 2G is an enlarged cross sectional view of a dough sheet taken along line 2G of FIG. 2A;

FIG. 3A is a schematic side elevation view of a cutter mechanism of the system;

FIG. 3B is a schematic cross sectional view of the cutter mechanism taken along line 3B-3B of FIG. 3A illustrating a ring and a mandrel thereof;

FIG. 3C is a rotated and flattened view of the cutter mechanism taken along line 3C-3C of FIG. 3A illustrating cutting segments thereof;

FIG. 3D is a schematic cross sectional view of the cutter mechanism taken along line 3D of FIG. 3C illustrating a cutting segment thereof;

FIG. 3E is a schematic cross sectional view of the cutter mechanism taken along line 3E of FIG. 3C illustrating a cutting edge between adjacent cutting segments;

FIG. 3F is a schematic cross sectional view of the cutter mechanism taken along line 3F-3F of FIG. 3A illustrating a rotating gas plate thereof;

FIG. 3G is a schematic side elevation view of the cutter mechanism with parts removed taken along line 3G-3G of FIG. 3A illustrating a stationary end plate thereof;

FIG. 4A is a schematic view of a gas discharge system of the system;

FIG. 4B is a schematic view of a portion of the cutter mechanism illustrating a connection with the gas discharge system;

FIG. 5 is a block diagram of a snack product fabrication system incorporating the system of FIGS. 1A-1B;

FIG. 6A is an enlarged front elevation view of a snack product fabricated in accordance with the invention;

FIG. 6B is a cross sectional view of the snack product taken along line 6B-6B of FIG. 6A; and

FIG. 6C is a cross sectional view of the snack product taken along line 6C-6C of FIG. 6A.

### DETAILED DESCRIPTION OF THE PREFERRED EMBODIMENTS

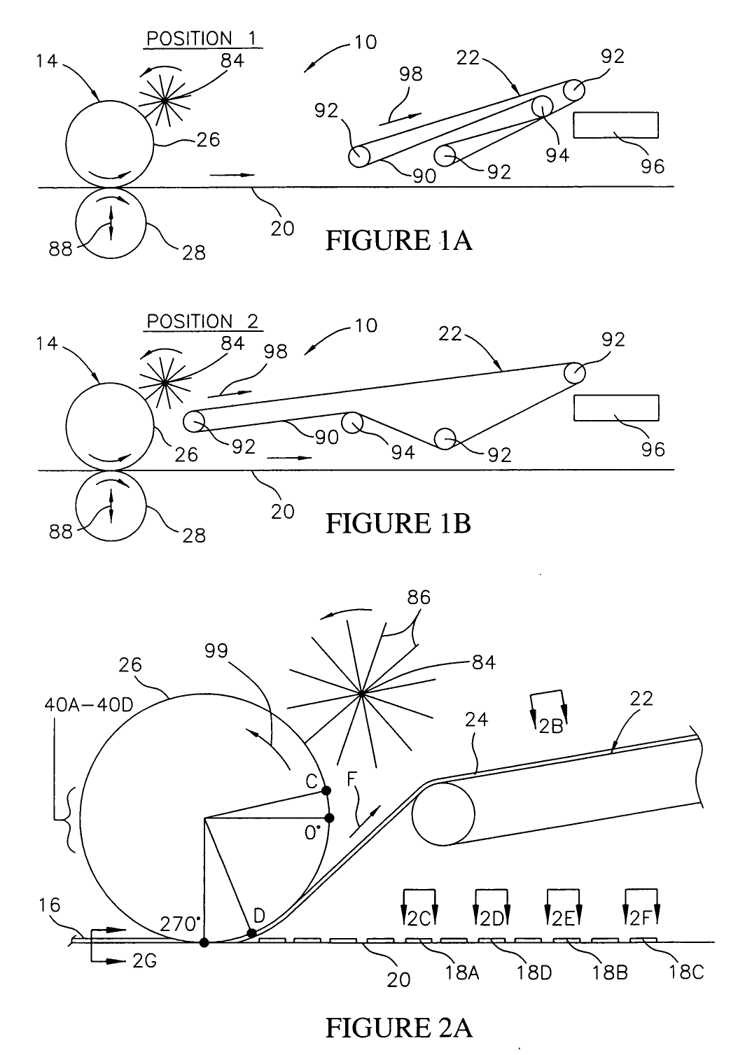

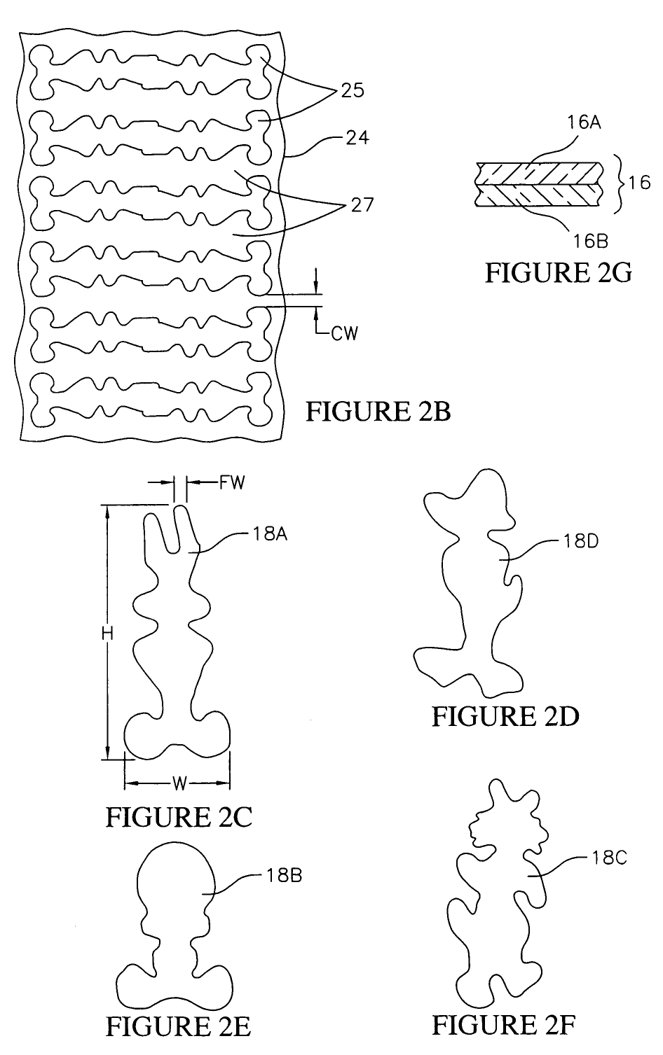

Referring to FIGS. 1A-1B and 2A-2G, a system 10 for making shaped snack products (e.g., snack product 12A-FIG. 6A) in accordance with the invention is illustrated.

The system 10 includes a cutter assembly 14 comprising a rotating cutter mechanism 26, a rotating back up roller 28, and a rotating brush 84. The cutter assembly 14 is configured to cut a dough sheet 16 (FIG. 2A) into a plurality of separate dough pieces 18A-18D (FIG. 2A). In the illustrative embodiment, the dough sheet 16 comprises two separate layers including a first dough layer 16A (FIG. 2G) and a second dough layer 16B (FIG. 2G). However, it is to be understood that the system 10 and process can be used with any dough sheet including single layer dough sheets and multi layer dough sheets.

In addition to the cutter assembly 14, the system 10 also includes a dough conveyor 20 configured to move the dough sheet 16 into the cutter assembly 14, and to move the cut dough pieces 18A-18D away from the cutter assembly 14. In addition, the system 10 includes a web scrap mechanism 22 configured to move a continuous web scrap 24 (FIG. 2A) from the cutter assembly 14 with a selected orientation relative to the dough pieces 18A-18D. In addition to moving and orienting the web scrap 24, the web scrap mechanism 22 allows the separate dough pieces 18A-18D (FIG. 2A) to more freely separate from the web scrap 24.

Referring to FIG. 2B, the web scrap 24 includes patterns of openings 25 wherein the dough pieces 18A-18D have been removed. In FIG. 2B, each opening 25 corresponds to two nested dough pieces 18A. Although only openings 25 for the dough pieces 18A are illustrated, the dough pieces 18B-18D will produce openings (not shown) corresponding to their shapes. In addition to the openings 25, the web scrap 24 includes connecting segments 27, which comprise remnant portions of the dough sheet 16 (FIG. 2A) following separation of the dough pieces 18A-18D.

Referring to FIGS. 2C-2F, the dough pieces 18A-18D are shown separately. A rabbit-shaped dough piece 18A is shown in FIG. 2C. A duck-shaped dough piece 18B is shown in FIG. 2D. A bird-shaped dough piece 18C is shown in FIG. 2E. A cat-shaped dough piece 18C is shown in FIG. 2F. However, these shapes are merely exemplary, and the dough pieces 18A-18D can be formed with any selected shape, such as animal, plant, human, vehicle, structure, and geographic shapes. Further, the dough pieces 18A-18D have intricate features including heads, ears, arms, legs, feet, tails and whiskers. However, these features are merely exemplary, and the dough pieces 18A-18D can be made with any selected feature.

In addition, the dough pieces 18A-18D have a selected height H, a selected width W, and selected feature widths FW. By way of example, the height H can be on the order of one to two inches, the width W can be on the order of a one fourth to one half inch, and the feature widths FW can be on the order of one sixteenth to one eight of an inch. Further, the connecting segments 27 (FIG. 2B) on the web scrap 24 can have a width CW (FIG. 2B) as small as about one tenth of an inch. However, these dimensions are merely exemplary, and the dough pieces 18A-18D can be made with any selected dimension.

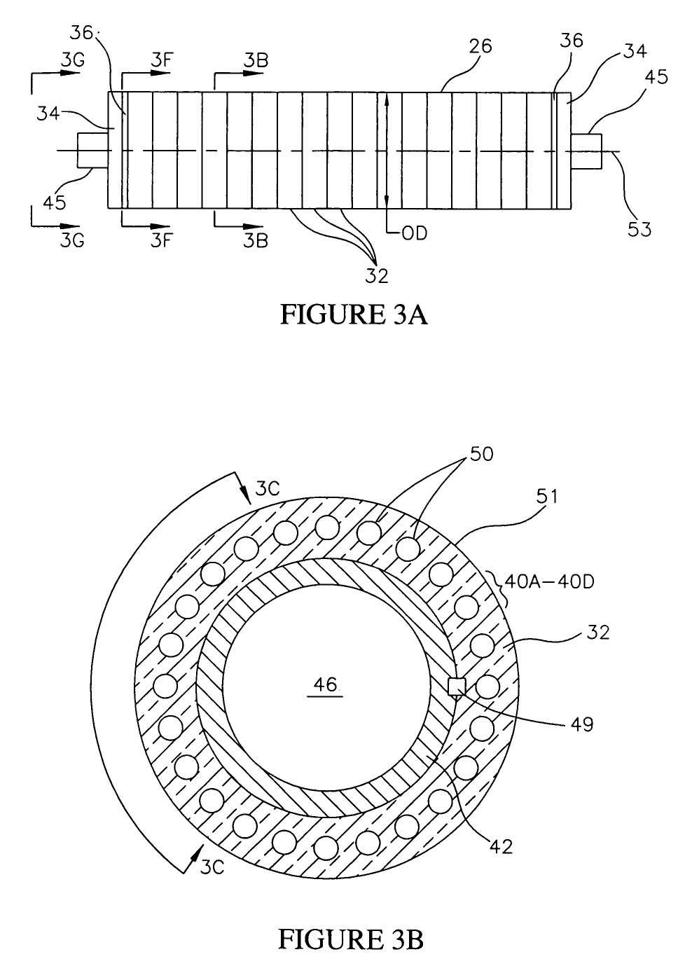

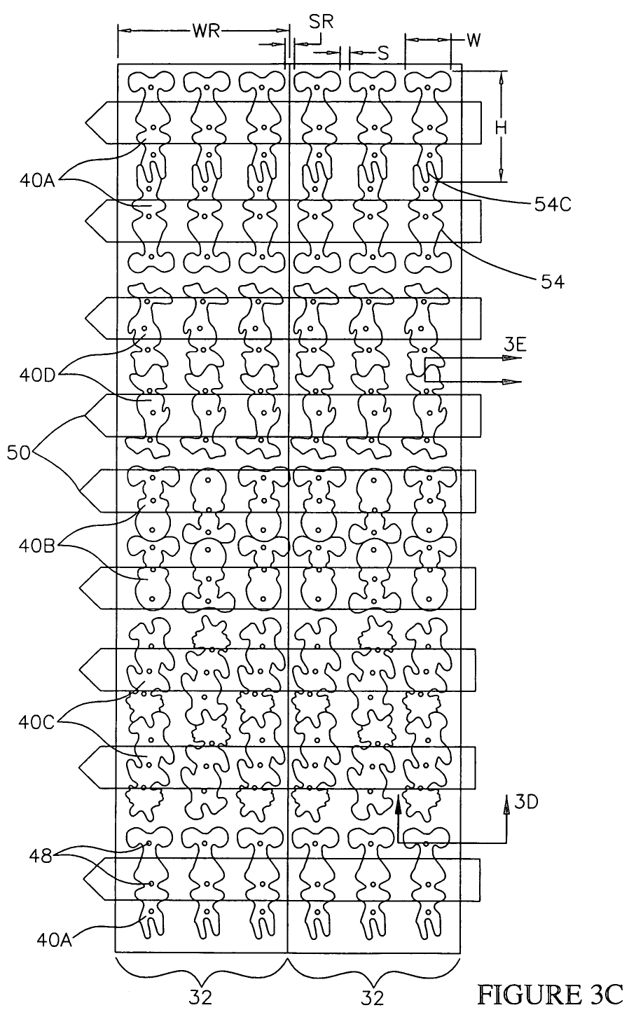

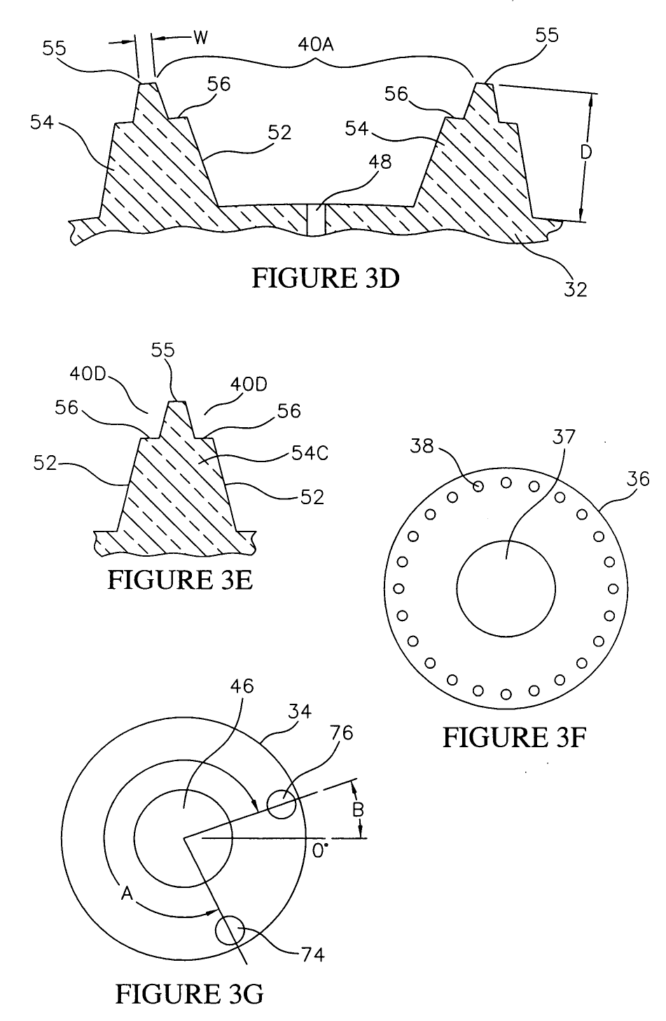

Referring to FIG. 3A, the cutter mechanism 26 comprises a cylindrical member having a selected length, and a selected diameter. By way of example, the length can be on the order of one to several feet, and the diameter D can be on the order of six to thirty inches. The cutter mechanism 26 includes a cylindrical mandrel 42 (FIG. 3B), and a plurality of separate rings 32, attached to the mandrel 42. The cutter mechanism 26 also includes a stationary port plate 34 at each end, and a rotating gas conduit plate 36 at each end.

The mandrel 42 includes cylindrical shafts 45 (FIG. 3A) at each end, and a hollow interior portion 46. The shafts 45 on the mandrel 42 allow the cutter mechanism 26 to be supported on bearings of a support structure (not shown), and driven by a suitable drive mechanism (not shown), such as sprockets and chains.

Referring to FIG. 3B, the mandrel 42 can be made of a metal, such as steel, stainless steel or bronze, and the rings 32 can be made of a plastic, metal or ceramic material. In addition, the rings 32 have inside diameters that are only slightly larger than an outside diameter of the mandrel 42, such that the rings 32 can be slid onto the mandrel 42. Further, a square key 49 attaches to mating keyways on the inside diameters of the rings 32, and on the outside diameter of the mandrel 42, such that the mandrel 42 and the rings 32 rotate in unison. In addition to transmitting rotary motion of the mandrel 42 to the rings 32, the key 49 also attaches and aligns the rings 32 on the mandrel 42.

Still referring to FIG. 3B, the cutter mechanism 26 also includes cutting segments 40A-40D (FIG. 3C) formed on the outside surfaces 51 of the rings 32, and configured to cut the dough sheet 16 (FIG. 2A) into the dough pieces 18A-18D (FIG. 2A). In addition, the cutter mechanism 26 includes gas conduits 50, which function to supply pressurized gas to the cutting segments 40A-40D, for ejecting the dough pieces 18A-18D from the cutting segments 40A-40D in a manner to be hereinafter described. The gas conduits 50 comprise circular openings in the rings 32 extending through the rings 32 and generally parallel to a longitudinal axis 53 (FIG. 3A) of the cutter mechanism 26. In the illustrative embodiment, there are twenty-four gas conduits 50 which are evenly spaced on a circle which bisects the thicknesses of the rings 32.

Referring to FIG. 3C, a pair of adjacent rings 32 are shown in a flattened view. In the illustrative embodiment, there are twenty-one rings 32 on the cutter mechanism 26 arranged end to end on the mandrel 42, with their outer surfaces 51 forming a continuous outside surface of the cutter mechanism 26. In addition, each ring 32 has a width WR of about 2.646 inches, and an outside diameter OD (FIG. 3A) of about 10.776 inches. Further, a spacing SR of the cutting segments 40A-40D on adjacent rings 32 is about 0.2719 inches. Again these dimensions are merely exemplary.

In the illustrative embodiment, the cutting segments 40A-40D have cartoon character shapes, with cutting segments 40A shaped as rabbits, cutting segments 40B shaped as birds, cutting segments 40C shaped as cats, and cutting segments 40D shaped as ducks. The width W and height H of the cutting segments 40A-40D correspond to the width W (FIG. 2C) and height H (FIG. 2C) of the dough pieces 18A-18D. In addition, a spacing S of the cutting segments 40A-40D corresponds to the width CW (FIG. 2B) of the connecting segments 27 (FIG. 2B) on the web scrap 24 (FIG. 2B).

Referring to FIG. 3D, a single cutting segment 40A is shown in cross section. The cutting segments 40A-40D comprise cups formed by shaped blades 54 on the outside surfaces 51 (FIG. 3B) of the rings 32. Each cutting segment 40A-40D is a cup having a peripheral shape defined by a single continuous shaped blade 54. As the rings 32 preferably comprise plastic or metal, the shaped blades 54 can be formed in the rings 32 using a suitable process such as machining, routing, etching or molding.

The area between the blades 54 defines the cutting segments 40A-40D as cups, which are configured to form and then temporarily retain the dough pieces 18A-18D. In FIG. 3D, the area bounded by the blades 54 forms the dough pieces 18A (FIG. 2C), and the openings 25 (FIG. 2B) in the web scrap 24 (FIG. 2B) for the dough pieces 18A. The area outside the blades 54 defines the connecting segments 27 (FIG. 2B) of the web scrap 24 (FIG. 2B).

As shown in FIG. 3D, the shaped blades 54 have a depth D which corresponds to a thickness of the dough pieces 18A-18D (FIG. 2A). By way of example, the depth D can be on the order of 0.05-0.25 inches or less. In addition, the shaped blades 54 include sharpened tips 55 having a width w on the order of about 1 to 10 mm.

The blades 54 are configured to cut through and press the dough sheet 16 (FIG. 2A) towards the surface of the back up roller 28 (FIG. 1A). To facilitate the cutting process, the back up roller 28 can be configured to float and apply an axial force as indicated by double headed arrow 88 in FIGS. 1A and 1B.

In addition to the sharpened tips 55, the blades 54 have stepped cutting edges 52 configured to cut and compress the edges of the dough pieces 18A-18D (FIG. 2A) as the dough sheet 16 (FIG. 2A) passes between the rotating cutter mechanism 26, and the rotating back up roller 28 (FIG. 1B). The stepped cutting edges 52 thus shape the dough pieces 18A-18D in the X and Y directions, and also shape the peripheral edges of the dough pieces 18A-18D in the Z direction.

In the illustrative embodiment, each cutting edge 52 has a stepped portion 56 configured to compress the edges of the dough pieces 18A-18D (FIG. 2A) against a resistance applied by the back up roller 28 (FIG. 1B). Further, the stepped cutting edges 52 are angled inward towards the centers of the cutting segments 40A-40D, such that the cutting segments 40A-40D decrease in size as the depth D increases. Stated differently, the cutting segments 40A-40D are largest near their outside areas and become smaller as the depth D increases. This shape also facilitates compression of the edges of the dough pieces 18A-18D, and permits the dough pieces 18A-18D to be more easily discharged from the cutting segments 40A-40D.

As shown in FIG. 3C, some of the cutting segments 40A-40D are formed in nested pairs having common shaped blades 54C (FIG. 3E). As shown in FIG. 3E, the common shaped blades 54C include stepped cutting edges 52, which function to cut and compress the edges of the dough pieces 18A-18D (FIG. 2)A, substantially as previously described.

As shown in FIG. 3D, each cutting segment 40A-40D includes one or more gas ports 48 in flow communication with the gas conduits 50 (FIG. 3B) located within the cutter mechanism 26. The gas ports 48 comprise cylindrical openings through the material of the rings 32 to the gas conduits 50 (FIG. 3B) within the rings 32. The gas ports 48 can be perpendicular to a central axis of the cutting segments 40A-40D, or can be angled with respect to the cutting segments 40A-40D.

The gas ports 48 are configured to direct a pressurized gas, such as air, at the dough pieces 18A-18D (FIG. 2A) contained within the cutting segments 40A-40D. The pressurized gas functions to discharge the dough pieces 18A-18D from the cutting segments 40A-40D onto the dough conveyor 20 (FIG. 2A). In addition, the pressurized gas functions to clean out obstructed or plugged gas ports 48 during a clean out cycle of the cutter mechanism 26.

Referring to FIG. 3F, the cutter mechanism 26 also includes the gas conduit plates 36 on each end, which are attached to the mandrel 42 (FIG. 3B) for rotation therewith. Each gas conduit plate 36 includes an opening 37 for the shaft 45 (FIG. 3A) on the mandrel 42 (FIG. 3B). Each gas conduit plate 36 also includes a plurality of gas openings 38 aligned with and in flow communication with the gas conduits 50 through the cutter mechanism 26.

Referring to FIG. 3G, the cutter mechanism 26 also includes the port plates 34 at each end, which are fixed relative to the rotating mandrel 42 (FIG. 3B) and the rotating gas conduit plates 36 (FIG. 3F). Each port plate 34 includes an opening 46 for the shaft 45 (FIG. 3A) on the mandrel 42 (FIG. 3B). Each port plate 34 also includes a discharge port 74 and a clean out port 76. The discharge ports 74 and the clean out ports 76 are configured to direct pressurized gas through the gas openings 38 in the gas conduit plates 36, and through the gas conduits 50 (FIG. 3B) in the cutter mechanism 26 to the gas ports 48 (FIG. 3D) in the cutting segments 40A-40D (FIG. 3C).

As the cutter mechanism 26 rotates, each of the gas openings 38 (FIG. 3F) on the gas conduit plates 36 (FIG. 3F) comes into alignment with the discharge ports 74, and then with the clean out ports 76 on the stationary port plates 34. The discharge ports 74 are located at an angle D selected to optimize the location of the discharge point D (FIG. 2A) of the dough pieces 18A-18D from the cutting segments 40A-40D. In FIG. 3G, the three o'clock position on the circular port plate 34 has been designated as zero. A representative value for the angle A for the discharge ports 74, measured from the three o'clock position, can be from about 275° to 285°. A representative value for the angle B for the clean out ports 76, measured from the three o'clock position, can be from about 10-20°.

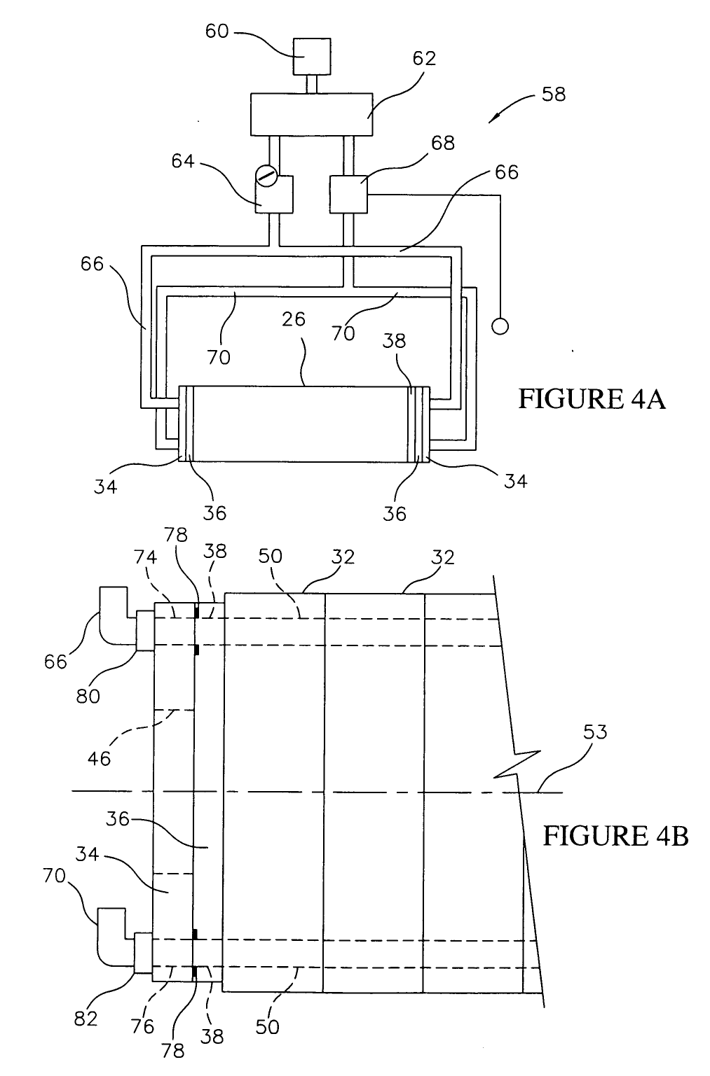

Referring to FIG. 4A, the system 10 also includes a gas discharge system 58 configured to provide pressurized gas to the discharge ports 74 (FIG. 3G) on the port plates 34 for discharging the dough pieces 18A-18D (FIG. 2A) from the cutting segments 40A-40D (FIG. 3C). The gas discharge system 58 is also configured to provide pressurized gas to the clean out ports 76 on the port plates 34, which is directed through the gas conduits 50 to the gas ports 48 in the cutting segments 40A-40D to remove any obstructions (e.g., dough plugs) from blocked or plugged gas ports 48.

The gas discharge system 58 includes a gas source 60, and an accumulation tank 62 in flow communication with the gas source 60. The gas source 60 can comprise a pressurized air source, such as a plant air supply. The accumulation tank 62 can comprise a sealed receiver having a required internal volume. The gas discharge system 58 also includes a pressure regulator valve 64 in flow communication with the accumulation tank 62, and with discharge lines 66. The discharge lines 66 are in flow communication with the discharge ports 74 (FIG. 3G) on the port plates 34. The regulator valve 64 is configured to adjust the gas pressure, such that the dough pieces 18A-18D discharge cleanly from the cutting segments 40A-40D.

The gas discharge system 58 also includes a clean out valve 68 in flow communication with clean out lines 70. The clean out lines 70 are in flow communication with the clean out ports 76 (FIG. 3G) on the port plates 34. The clean out lines 70 are configured to provide pressurized gas for removing obstructions (e.g., dough plugs) from the gas ports 48. In addition, the clean out valve 68 is in signal communication with a manual activation switch 72, such that manual cleaning can be performed.

Referring to FIG. 4B, further details of the gas discharge system 58 are illustrated. The discharge lines 66 are attached to discharge fittings 80 on the stationary port plates 34. The discharge fittings 80 are in flow communication with the discharge ports 74 on the port plates 34, which as previously explained sequentially communicate with the gas openings 38 on the gas conduit plates 36. The clean out lines 70 are attached to clean out fittings 82 on the stationary port plates 34. The clean out fittings 82 are in flow communication with the clean out ports 76, which as previously explained sequentially communicate with the gas openings 38 on the gas conduit plate 36. As also shown in FIG. 4B, seals 78 are positioned between the stationary port plate 34 and the rotating gas conduit plate 36.

Referring to FIG. 2A, the cutter mechanism 26 also includes a brush 84 configured to remove dough pieces 18A-18D, or portions thereof, from the cutter mechanism 26 that do not cleanly discharge from, or clean out of the cutting segments 40A-40D (FIG. 3C) during the clean out cycle. The brush 84 can comprise a plurality of bristles made of a flexible material such as nylon. In addition, the brush 84 can be mounted proximate to the cutter mechanism 26 for counter rotation imparted by rotation of the cutter mechanism 26. The dough pieces 18A-18D, or portions thereof, removed by the brush tend to fall on the moving web scrap 24.

Referring to FIGS. 1A and 1B, the web scrap mechanism 22 will be described in greater detail. In the illustrative embodiment, the web scrap mechanism 22 comprises an endless conveyor belt 90 mounted on rollers 92. At least one of the rollers 92 is driven by a suitable drive mechanism to move the conveyor belt 90 as indicated by directional arrow 98. In addition, a movable roller 94 is connected to a hydraulic mechanism (not shown), and is configured to position the web scrap mechanism 22 in “Position 1” shown in FIG. 1A, “Position 2” in FIG. 1B, or any position between “Position 1” and “Position 2”.

In general, “Position 1” can be used for separating dough pieces 18A-18D (FIG. 2A) having a relatively large size (e.g., 2 inch diameter ovals), and when the web scrap 24 has a relatively small proportion relative to the uncut dough sheet 16 (e.g., 5%˜35%). Position 2, can be used for separating small dough pieces 18A-18D (FIG. 2A), and when the web scrap 24 has a relatively large proportion relative to the uncut dough sheet 16 (e.g., 30%-60%). Position 1 can also be used at the start up of a process for separating dough pieces 18A-18D (FIG. 2A), and Position 2 used after a steady state has been reached.

In Position 1, the conveyor belt 90 of the web scrap mechanism 22 is spaced from the cutter mechanism 26 by a relatively large distance (e.g., 4 inches to 8 inches from edge of belt 90 to edge of cutter mechanism). Also in Position 1, the web scrap 24 is pulled from the cutter mechanism 26 by the conveyor belt 90 with a relatively shallow angular orientation (e.g., 5° to 25° from a horizontal plane). In Position 2, the conveyor belt 90 of the web scrap mechanism 22 is spaced from the cutter mechanism 26 by a relatively small distance (e.g., one inch to 3 inches). Also in Position 2, the web scrap 24 is pulled from the cutter mechanism 26 by the conveyor belt 90 with a relatively large angular orientation (e.g., 25° to 75° from a horizontal plane).

The conveyor belt 90 of the web scrap mechanism 22 can comprise a material such as urethane or rubber, capable of exerting a pulling force F (FIG. 2A) on the web scrap 24. Suitable conveyor belts are commercially available from Falcon Belting Inc., of Oklahoma City, Okla. A width of the conveyor belt 90 can be slightly larger than the width of the web scrap 24 (e.g., one inch to two inches greater on each side). A conveying length of the conveyor belt 90 can be on the order of one to two feet in Position 1, and three to six feet in Position 2. A speed of the conveyor belt 90 can be from 1-2% faster than the speed of the cutter assembly 14 and the dough conveyor 20. A representative speed of the conveyor belt 90 can be from four feet/minute to 100 feet/minute.

As also shown in FIGS. 1A and 1B, a cross conveyor 96 is positioned generally orthogonal to the web scrap mechanism 22. The cross conveyor 96 is configured to receive the web scrap 24 from the web scrap mechanism 22, and to convey the web scrap 24 to a desired location (e.g., recycle point). The cross conveyor 96, and the dough conveyor 20 as well, can include conveyor belts formed of a material such as urethane or rubber, and can include suitable mounting rollers (not shown).

Referring to FIG. 2A, during operation of the system 10 the uncut dough sheet 16 is conveyed by the dough conveyor 20 into the cutter mechanism 26. As the cutter mechanism 26 rotates counter clockwise as indicated by directional arrow 99, the row of cutting segments 40A-40D at the 270° position contact the dough sheet 16 and cut the dough pieces 18A-18D. Following these particular cutting segments 40A-40D, between the 270° position and the D discharge position of the cutter mechanism 26, the dough pieces 18A-18D are retained in these particular cutting segments 40A-40D. By way of example, the D discharge position can be located at an angle between about 275° to 285° measured from the three o'clock point of the counter rotating cutter mechanism 26.

At the D discharge position of the cutter mechanism 26, the discharge ports 74 (FIG. 3G) in the port plates 34 (FIG. 3G) allow pressurized gas to flow through the gas openings 38 (FIG. 3F) in the gas conduit plate 36 (FIG. 3F), and through the gas conduits 50 (FIG. 3B) associated with these cutting segments 40A-40D. The pressurized gas is directed through the gas ports 48 in the cutting segments 40A-40D and ejects the dough pieces 18A-18D out of the cutting segments 40A-40D and onto the dough conveyor 20.

Also at the D discharge position of the cutter mechanism 26, the web scrap 24 is moved by the web scrap mechanism 22 and oriented at an angle relative to the dough pieces 18A-18D. The movement and angular orientation of the web scrap 24 moves the connecting segments 27 (FIG. 2B) on the web scrap 24 away from the dough pieces 18A-18D, such that they can be easily separated from the cutting segments 40A-40D, and from the openings 25 (FIG. 2B) in the web scrap 24, by the pressurized gas. At the same time, the separated dough pieces 18A-18D are moved by the dough conveyor 20 away from the cutter mechanism 26. In addition, the web scrap mechanism 22 exerts a force F on the web scrap 24, and slightly stretches the web scrap 24. The separation of the dough pieces 18A-18D from the web scrap 24 is thus performed by the combination of gas pressure on the dough pieces 18A-18D, movement of the web scrap 24 away from the dough pieces 18A-18D, angular orientation of the web scrap 24 relative to the dough pieces 18A-18D, and movement of the dough pieces 18A-18D away from the web scrap 24. This separation process allows small intricately shaped dough pieces 18A-18D to be removed efficiently and with minimal damage to the dough pieces 18A-18D.

At the C clean out position of the cutter mechanism 26, the clean out ports 76 (FIG. 3G) in the port plates 34 (FIG. 3G) allow pressurized gas to flow through the gas openings 38 (FIG. 3F) in the gas conduit plate 36 (FIG. 3F), and through the associated gas ports 48 in the cutting segments 40A-40D to clean out obstructed or plugged gas ports 48. Any partial dough pieces, such as dough plugs, drop onto the web scrap 24 and travel with the web scrap 24 to the cross conveyor 96 (FIG. 1A). The brush 84 also helps to separate any partial dough pieces from the cutter mechanism 26.

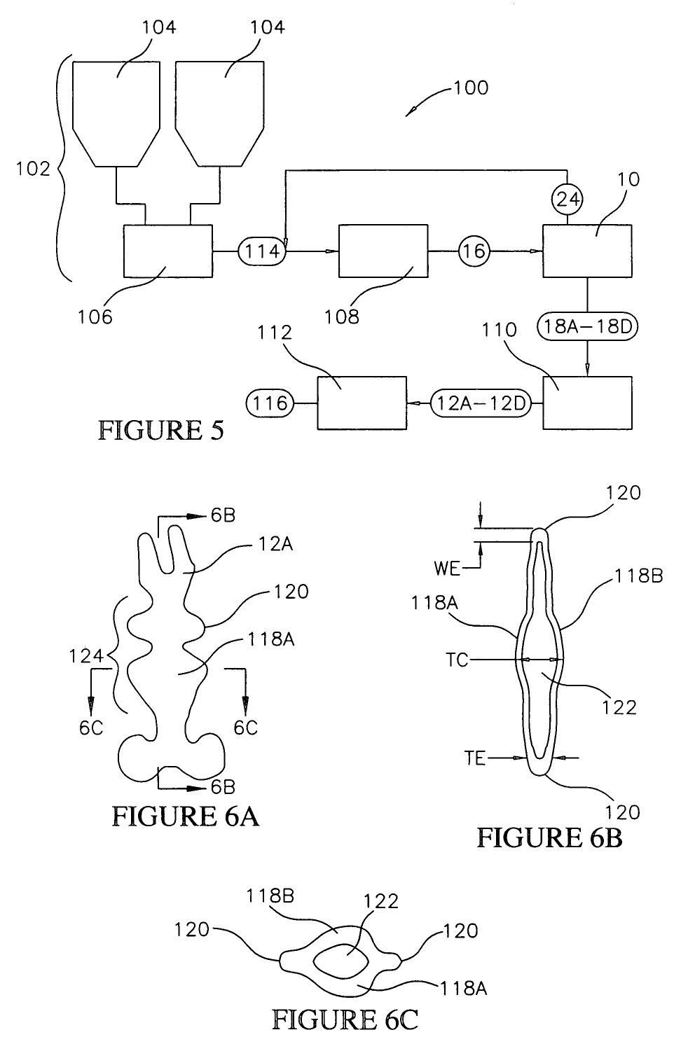

Referring to FIG. 5, a snack product fabrication system 100 incorporating the system 10 of FIGS. 1A-1B, is illustrated. In addition to the system 10, the snack product fabrication system 100 includes a mixing system 102 configured to mix ingredients to form a dough 114, a sheeting system configured to sheet the dough 114 into the dough sheet 16, a cooking system 110 configured to cook the dough pieces 18A-18D into a plurality of snack products 12A-12D, and a packaging system 112 configured to package the snack products 12A-12D into packages 116.

The mixing system 102 can include one or more storage containers 104 configured to store ingredients for making the dough 114. The mixing system 102 can also include a mixer 106 configured to mix the ingredients with an appropriate quantity of water. Suitable mixers are commercially available from Stephan Machinery Corporation of West Germany, and Hobart Corporation of Troy, Ohio, as well as others.

The dough ingredients can include conventional starch-containing foods traditionally used to make snack products. U.S. Pat. No. 4,756,920 to Willard, U.S. Pat. Nos. 4,889,733 and 4,889,737 to Willard et al., U.S. Pat. Nos. 4,931,303 and 4,994,295 to Holm et al., and U.S. Pat. No. 5,366,749 to Frazee et al., all of which are incorporated herein by reference, describe various dough formulations.

In the illustrative embodiment, potato flakes, corn flour and water are the main ingredients of the dough 114. However, the dough 114 can also include other ingredients, such as raw or pre-gelatinized starches, modified starches, flavorings, oils, preservatives and whole cereal grains. These ingredients are mixed with an appropriate quantity of water to achieve a desired dough consistency having a moisture content of from about 35% to 60%.

The sheeting system 108 can comprise one or more pairs of sheeting rolls configured to compress the dough 114 into the dough sheet 16. Dough rollers are widely used in the manufacture of conventional sheeted snack products and are commercially available from Reading Bakery Systems of Robesonia, Pa., as well as others. Rather than rollers, the sheeting system 108 can include conventional extruders or presses suitable for making the dough sheet 16. By way of example, the dough sheet 16 can have a thickness in the range of about 0.5 mm to about 1.5 mm.

The dough sheet 16 can be fed into the system 10 (FIG. 1A-1B) to form the dough pieces 18A-18D, substantially as previously described. In addition, the web scrap 24 can be combined with the dough 114 prior to introduction into the sheeting system 108.

The cooking system 110 is configured to cook the dough pieces 18A-18D into the snack products 12A-12D. In the illustrative embodiment, the cooking system 110 comprises a frying system having a bath containing cooking oil at an elevated temperature (e.g., 325° F. (165° C.) to 400° F. (205° C.). The dough pieces 18A-18D can be fried for a time period sufficient to produce a final moisture content of about 1-2%. A frying system can also include mechanisms such as submerging belts, nozzles and wires configured to submerge the dough pieces 18A-18D in the cooking oil. Suitable cooking systems are commercially available from Heat and Control Inc. of Hayward, Calif., as well as others.

The packaging system 112 is configured to package the snack products 12A-12D into packages 116. The packaging system 112 can comprise conventional packaging equipment used in the snack product industry. Suitable packaging systems are commercially available from Heat and Control Inc. of Hayward, Calif., as well as others.

The snack product fabrication system 100 can optionally include a dockering system configured to docker the dough sheet 16 or the dough pieces 18A-18D to reduce bubbles or pillows that can form in fried snack products. One such dockering system is described in U.S. Pat. No. 4,889,737 to Willard et al., which is incorporated by reference.

Referring to FIGS. 6A-6C, a shaped snack product 12A fabricated using the fabrication system 100 is illustrated. The shaped snack product 12A was made from the dough sheet 16 having the first dough layer 16A (FIG. 2G) and the second dough layer 16B (FIG. 2G). The dough piece 18A (FIG. 2C) for making the snack product 12A had these same two layers (dough layers 16A and 16B in FIG. 2G).

The snack product 12A includes a first cooked dough layer 118A, which corresponds to the first dough layer 16A (FIG. 2G), and a second cooked dough layer 118B, which corresponds to the second dough layer 16B (FIG. 2G). The cooked dough layers 16A, 16B terminate at a continuous shaped edge 120, which defines the outer periphery of the snack product 12A. In addition, the continuous shaped edge 120 and the outer surfaces of the cooked dough layers 16A, 16B forms an enclosed, sealed chamber 122.

Recall that the continuous shaped edge 120 of the cooked dough layers 16A, 16B has been compressed and sealed by the stepped cutting edge 52 (FIG. 3D) on the particular cutting segment 40A which formed the dough piece 18A. The shaped edge 120 completely encircles the outer periphery of the snack product 12A, and can be described as a crimped and sealed edge. During cooking of the dough piece 18A, gases are trapped between the dough layers 16A, 16B forming the chamber 122. However, the shaped edge 120 is able to resist deformation by the gases, such that the chamber 122 has a curved or bulging outside surface. The chamber 122 can thus be described as having been formed by “controlled pillowing” using two dough layers 16A, 16B having a continuous shaped edge 120.

The snack product 12A can be described as having a three dimensional shape similar to a molded plastic toy, such as a small soldier. In addition, the snack product 12A can be described as having a bulging center portion 124 (FIG. 6A), as the chamber 122 has curved outside surfaces formed by a single cooked dough layer 118A or 118B. Further, an edge thickness TE of the snack product 12A proximate to the shaped edge 120 is close to the original thickness of the dough sheet 16 (FIG. 2G). This edge thickness TE makes intricate features, such as the ears and feet of the snack product 12A, as relatively rigid structures, because they are primarily formed by the shaped edge 120. Still further, as the shaped edge 120 includes portions of both cooked dough layers 118A, 118B it has a double thickness, which provides a rigid outer support structure for the snack product 12A, and a crunchy volume of cooked dough during consumption of the snack product 12A.

In contrast, a center thickness TC of the center portion 124 (FIG. 6A) of the snack product 12A can be several times greater than the edge thickness TE. By way of example, if the snack product 12A is made from a dough piece 18A (FIG. 2C) having a height H of 40.5 mm, a width of 18.5 mm, and a thickness of 1.35 mm, a representative range for the edge thickness TE can be from 0.8 mm to 1.35 mm, a representative range for the center thickness TC can be from 4.5 mm to 7.0 mm, and a representative range for an edge width WE can be from 0.5 mm to 2.5 mm.

Thus the invention provides a process and a system for making shaped snack products, and a snack product fabricated using the process and system. Although the invention has been described with reference to certain preferred embodiments, as will be apparent to those skilled in the art, certain changes and modifications can be made without departing from the scope of the invention, as defined by the following claims.

1. A process for fabricating a snack product comprising
providing a dough sheet;
cutting a dough piece and a web scrap in the dough sheet; and
separating the dough piece from the web scrap by directing a pressurized gas at the dough piece while moving the web scrap at an angle relative to the dough piece.

2. The process of claim 1 wherein the cutting step comprises pressing a stepped cutting edge against the dough sheet.

3. The process of claim 2 wherein the dough comprises a first dough layer and a second dough layer, and the stepped cutting edge forms the dough piece with a sealed edge.

4. The process of claim 3 further comprising cooking the dough piece following the separating step to form a sealed chamber bounded by the sealed edge.

5. The process of claim 4 wherein the separating step further comprises moving the dough piece away from the web scrap.

6. A process for fabricating a snack product comprising:
providing a dough sheet;
providing a cutter mechanism comprising a cutting segment having a continuous shaped cutting edge;
pressing the cutting edge against the dough sheet to form a dough piece retained by the cutter segment and a web scrap;
directing a pressurized gas at the dough piece to discharge the dough piece from the cutter segment; and
moving the web scrap at an angle to the dough piece during the directing step.

7. The process of claim 6 wherein the cutter mechanism comprises a rotating cylindrical member comprising a ring having the cutting edge formed on an outside surface thereof.

8. The process of claim 6 wherein the shaped cutting edge includes a stepped surface.

9. The process of claim 6 wherein the cutter mechanism includes a gas conduit, and a gas port in the cutting segment in flow communication with the gas conduit, the gas conduit and the gas port configured to perform the directing step.

10. The process of claim 6 further comprising moving the dough piece away from the cutter mechanism during the directing step.

11. The process of claim 6 further comprising following the directing step, performing a cleaning step by directing the pressurized gas into the cutter segment.

12. The process of claim 6 further comprising following the directing step brushing the cutting segment.

13. The process of claim 6 wherein the cutter mechanism comprises a plurality of cutting segments having a plurality of common cutting edges.

14. A process for fabricating a snack product comprising:
providing a dough sheet having a first layer and a second layer;
cutting the dough sheet into a web scrap having an opening and a dough piece in the opening having a continuous crimped edge;
separating the dough piece from the web scrap by directing a pressurized gas at the dough piece while moving the dough piece and moving the web scrap with a selected orientation relative to the dough piece; and
cooking the dough piece to expand a center portion of the dough piece into a hollow chamber bounded by the crimped edge and by portions of the first layer and the second layer.

15. The process of claim 14 wherein the cutting step is performed using a stepped cutting edge.

16. The process of claim 14 wherein the dough piece includes a plurality of features proximate to the crimped edge.

17. The process of claim 14 wherein the cooking step comprises frying.

18. The process of claim 14 wherein the crimped edge has a thickness less than that of the dough sheet.

19. The process of claim 14 wherein the cutting step is performed using a rotating cylindrical cutter mechanism having a plurality of cutting segments for forming the dough piece and the web scrap.

20. The process of claim 14 wherein the first layer and the second layer comprise potato flakes.

21. A system for fabricating a snack product comprising:
a rotatable cutter mechanism comprising a plurality of shaped blades configured to cut a dough sheet into a web scrap having openings and a plurality of dough pieces in the openings;
a gas discharge system configured to direct separate gas streams at the dough pieces at a selected position of the cutter mechanism; and
a web scrap conveyor configured to move and orient the web scrap at a selected angle, as the gas streams are directed at the dough pieces.

22. The system of claim 21 wherein the selected position is between about 275° to 285° measured from 0° located at a three o'clock point of the cutter mechanism.

23. The system of claim 22 wherein the selected angle is from about 5° to 75° measured from a horizontal plane.

24. The system of claim 23 wherein the cutter mechanism includes a cylindrical mandrel and at least one ring attached to the mandrel having the shaped blades on an outside surface thereof.

25. The system of claim 24 wherein the ring includes a gas discharge conduit located generally parallel to a longitudinal axis of the cutter mechanism and a gas port in flow communication with the gas discharge conduit.

26. The system of claim 25 wherein the shaped blades have stepped cutting edges configured to compress edges of the dough pieces.

27. A system for fabricating a shaped snack product comprising:
a cutter mechanism comprising a plurality of cutting segments comprising shaped blades having cutting edges configured to cut a dough sheet into a plurality of dough pieces and a web scrap;
a gas discharge system configured to direct separate gas streams at the dough pieces contained in the cutting segments; and
a web scrap mechanism configured to move the web scrap at an angle relative to the dough pieces, as the gas streams are directed at the dough pieces held in the cutting segments.

28. The system of claim 27 wherein the cutter mechanism comprises a rotatable cylindrical mandrel and a ring on the mandrel having the cutting segments formed on an outside surface thereof.

29. The system of claim 27 wherein the cutter mechanism includes a gas conduit and a plurality of gas ports in flow communication with the gas conduits configured to direct the gas streams at the dough pieces.

30. The system of claim 27 wherein the cutting edges are stepped surfaces configured to compress peripheral edges of the dough pieces.

31. The system of claim 27 wherein the web scrap mechanism comprises a conveyor spaced from the cutter mechanism and positioned at the angle.

32. The system of claim 27 wherein the angle is from about 5° to 75° measured from a horizontal plane.

33. The system of claim 27 wherein the dough sheet includes a first dough layer and a second dough layer.

34. The system of claim 27 further comprising a rotatable brush configured to brush the cutter mechanism.

35. The system of claim 27 further comprising a cooking system configured to cook the dough pieces.

36. The system of claim 27 further comprising a mixing system configured to mix ingredients for the dough sheet.

37. The system of claim 27 further comprising a sheeting system configured to form the dough sheet.

38. The system of claim 27 further comprising a packaging system configured to package the dough pieces following cooking thereof.

39. A system for fabricating a shaped snack product comprising:
a cutter mechanism comprising a rotatable cylindrical mandrel having a longitudinal axis and at least one ring attached to the mandrel, the ring comprising a plurality of shaped blades on an outside surface thereof configured to cut a dough sheet into a web scrap and a plurality of dough pieces;
the ring further comprising a plurality of gas discharge conduits comprising openings therein positioned generally parallel to the longitudinal axis, and a plurality of gas ports in flow communication with the gas discharge conduits configured to direct a pressurized gas at the dough pieces at a selected position of the cutter mechanism; and
a web scrap mechanism configured to move the web scrap at an angle relative to the dough pieces, as the gas streams are directed at the dough pieces.

40. The system of claim 39 wherein the mandrel comprises a metal and the ring comprises a plastic or a metal.

41. The system of claim 39 further comprising a key attaching the ring to the mandrel.

42. The system of claim 39 further comprising a gas conduit plate attached to the mandrel having a plurality of gas openings in flow communication with the gas discharge conduits, and a gas port plate in flow communication with a gas supply having a discharge port configured to align with the gas openings as the cutter mechanism rotates.

43. The system of claim 42 wherein the gas port plate includes a clean out port in flow communication with the gas supply configured to align with the gas openings as the cutter mechanism rotates.

44. The system of claim 39 further comprising a rotatable back up roller configured to press the dough sheet into the cutter mechanism.

45. The system of claim 39 further comprising a rotatable brush configured to brush the dough pieces or portions thereof from the cutter mechanism.

46. The system of claim 39 wherein the web scrap mechanism comprises a conveyor having a conveyor belt spaced from the cutter mechanism and positioned at the angle.

47. The system of claim 46 wherein the conveyor is movable from a first position to a second position for changing the angle and a spacing of the conveyor from the cutter mechanism.

48. A shaped snack product comprising:
a first cooked dough layer and a second cooked dough layer;
a shaped peripheral edge comprising a first portion of the first cooked dough layer and a second portion of the second cooked dough layer compressed together;
a chamber having a hollow interior and bounded by the shaped peripheral edge; and
a middle portion comprising a first curved surface comprising the first cooked dough layer and a second curved surface comprising the second cooked dough layer.

49. The snack product of claim 48 wherein an edge thickness of the shaped peripheral edge is equal to or less than a combined thickness of the first cooked dough layer and the second cooked dough layer.

50. The snack product of claim 49 further comprising a plurality of features proximate to the peripheral edge comprised at least in part of the first portion and the second portion.

51. The snack product of claim 50 wherein the peripheral edge defines a shape of the snack product and forms a support structure for the features.
